(19) United States
(12) Patent Application Publication
(10) Pub. No.: US 2017/0363351 A1
(43) Pub. Date: Dec. 21, 2017

(54) METHOD AND APPARATUS FOR SEPARATING A FEED GAS CONTAINING AT LEAST 20 MOL % OF CO2 AND AT LEAST 20 MOL % OF METHANE, BY PARTIAL CONDENSATION AND/OR BY DISTILLATION

(71) Applicant: L'Air Liquide, Société Anonyme pour I'Etude et I'Exploitation des Procédés Georges Claude, Paris (FR)

(72) Inventors: Benjamin CAILLAT, Huningue (FR); Mathieu LECLERC, Paris (FR); Paul TERRIEN, Paris (FR)

(21) Appl. No.: 15/534,783

(22) PCT Filed: Nov. 26, 2015
(86) PCT No.: PCT/FR2015/053235

§ 371 Date: Jun. 9, 2017

(30) Foreign Application Priority Data
Dec. 11, 2014 (FR) 1462212

(51) Int. Cl. F25J 3/02; F25J 3/06

(52) U.S. Cl. CPC F25J 3/0209; F25J 3/0266; F25J 3/061; F25J 3/0635; F25J 3/067; F25J 3/0233; F25J 2230/08; F25J 2220/82; F25J 2215/04; F25J 2210/04; F25J 2205/80; F25J 2205/40; F25J 2205/04; F25J 2200/70; F25J 2200/40; F25J 2200/02; F25J 2230/32; F25J 2230/80; F25J 2235/80; F25J 2240/02; F25J 2270/02; F25J 2245/02

(57) ABSTRACT

The invention relates to a method for separating a feed gas containing at least 20 Mol % of CO2 and at least 20 Mol % of methane, by partial condensation and/or by distillation, the gas at a pressure of at least 40 bar abs, including expanding at least one portion of the feed gas in a turbine producing an expanded feed stream at a pressure of less than 90 bar abs, separating at least one portion of the expanded feed stream by partial condensation and/or by distillation thus obtaining a CO₂-depleted gas and a CO₂-enriched liquid, wherein the temperature of the expanded feed gas at the outlet of the turbine is below −56.6° C., and wherein the process does not use an external refrigeration source; and wherein the CO₂-depleted gas is introduced into a supplementary separation step, in order to obtain a stream that is more depleted in CO₂ and a CO₂-rich stream.

### CROSS REFERENCE TO RELATED APPLICATIONS

This application is a 371 of International PCT Application PCTFR2015/053235 filed Nov. 20, 2015 which claims priority to French Patent Application No. 1462212 filed Dec. 11, 2014, the entire contents of which are incorporated herein by reference.

### BACKGROUND

The present invention relates to a process for separating a feed gas containing at least 20 mol % of CO₂ and at least 20 mol % of methane, by partial condensation and/or by distillation.

The gas may contain up to 80 mol % of CO₂. In other cases, it may contain up to 80% of methane.

The natural resources of natural gas may be of various types, mainly in terms of composition. The traditional sources are extracted from the subsoil with a composition naturally rich in methane and with, as main secondary constituents, other hydrocarbons (C2, C3, etc.).

Increasingly often, the exploitation of sour natural gas deposits is considered. Typically, the H₂S content may become significant in certain cases and the CO₂ content may become high or even very high in certain cases ranging up to 80 mol % of CO₂. The present invention proposes a process that is optimized for example for the exploitation of natural gas with a high CO₂ content.

The present invention describes a method for treating a mixture containing at least methane and carbon dioxide in an optimized manner. Typically, this method enables the purification of a CO₂-rich natural gas in an effective manner.

Several methods are found in the prior art for treating a CO₂-rich natural gas.

US-A-2013/0036765 presents a process for treating a natural gas containing CO₂. The process uses a partial condensation of CO₂ and a distillation and makes it possible to obtain a CO₂-depleted fluid and a CO₂-rich liquid. However, this process does not make it possible to treat a fluid at very high pressure since the separation of the CO₂—CH₄ mixture is not possible above a certain pressure by simple separation methods. The value of this maximum pressure depends on the exact composition of the mixture but is at most around 90 bara.

EP-A-1 680 208 presents a method for separating a CO₂-rich gas using a cryogenic process and also membranes; however, again, this process does not make it possible to effectively treat a gas under pressure.

### Summary

The invention proposes a method for treating a mixture containing at least methane and CO₂ (at least 10 mol %, preferably at least 20 mol %) under pressure, comprising at least one step of expanding at least one portion of the mixture followed by a step of separating, by partial condensation and/or by distillation, at least one portion of the mixture.

According to one subject of the invention, a process is provided for separating a feed gas containing at least 20 mol % of CO₂ and at least 20 mol % of methane, by partial condensation and/or by distillation, the gas being at a pressure of at least 40 bar abs, comprising at least the following steps:

a. expanding at least one portion of the feed gas in a turbine producing an expanded feed stream at a pressure of less than 90 bar abs,

b. separating at least one portion of the expanded feed stream by partial condensation and/or by distillation thus obtaining a CO₂-depleted gas and a CO₂-enriched liquid,

wherein the temperature of the expanded feed gas at the outlet of the turbine is below −56.6° C., or even below −59° C. and wherein the process does not use an external refrigeration source.

According to other optional aspects:
the feed gas may contain at least 60 mol % of CO₂, or even at least 80 mol % of CO₂;
the feed gas may contain at least 60 mol %, or even at least 80 mol % of methane;
the feed gas may contain components other than CO₂ and methane;
at least one portion of the refrigeration energy is produced by the vaporization of CO₂-enriched liquid;
at least one portion of the refrigeration energy is provided by expansion in one or more turbines of all or some of the CO₂-depleted gas;
the feed stream is cooled in a heat exchanger upstream of the turbine;
the feed stream is cooled in the heat exchanger by heat exchange with at least one CO₂-depleted gas and/or at least one CO₂-enriched liquid originating from the separation of step b.;
the inlet temperature of the turbine is below −20° C.;
the expanded feed stream contains a liquid fraction;
the expanded feed stream contains a gaseous fraction;
the outlet temperature of the turbine is below the triple point of CO₂;
at least one portion of the gas phase of the expanded feed stream is compressed without first being heated or is heated by at most 5° C. upstream of the compression step;
the CO₂-depleted gas is then introduced into a supplementary separation step, for example a membrane separation step, in order to obtain a stream that is more depleted in CO₂ and a CO₂-rich stream which is optionally recycled upstream of step b.;
the expansion energy recovered in the turbine during phase a. is used to pressurize one or more of the following gases:
   at least one portion of the CO₂-enriched liquid after vaporization;
   at least one portion of the CO₂-depleted gas;
   at least one portion of the stream that is more depleted in CO₂;
   at least one portion of the CO₂-rich stream;
step b. comprises at least one step of distillation with reboiling and the overhead gas from the distillation column is recycled upstream of step b.;
the overhead gas from the distillation column is recycled upstream of step a.;
the overhead gas from the distillation column is compressed in one and the same compressor as the CO₂-rich stream, the gas and the stream optionally being introduced at different stages, before being recycled upstream of step b.;
the stream that is more depleted in CO₂ is injected into a line, optionally after compression.

The invention will be described in further detail by referring to the figures that illustrate processes according to the invention.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates a process of separation by partial condensation and by distillation, in accordance with one embodiment of the present invention.

FIG. 2 illustrates a process without membrane recycle and/or column overhead recycle, in accordance with one embodiment of the present invention.

### DESCRIPTION OF PREFERRED EMBODIMENTS

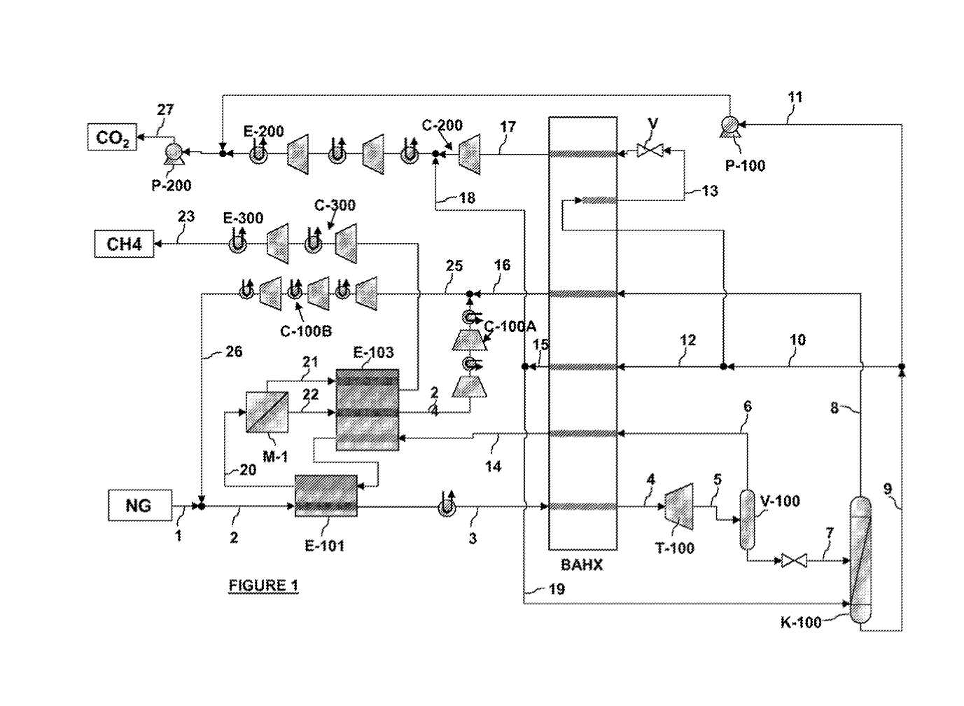

In FIG. 1, a process of separation by partial condensation and by distillation is illustrated.

A natural gas stream 1, 2 at a pressure of at least 40 bar abs containing between 20 and 80 mol % of methane and between 20 and 80 mol % of carbon dioxide is cooled in an exchanger E-101 and then by a cooler in order to form a stream 3. This stream 3 is cooled in a brazed aluminum plate-fin heat exchanger BAHX in order to cool the gas 4 to a temperature of around −30° C.

The principle is to cool the stream before a turbine T-100 to around −30° C., then to expand the gas 4 in a turbine typically up to between 35 and 50 bar, at most up to 90 bar. This expansion may in particular make it possible to achieve temperatures below the temperature of the triple point of CO₂. This is because the CO₂—CH₄ mixture only freezes at lower temperatures. The lower this temperature, the more effective the process in terms of CO₂ yield. A typical operation point is around −60° C. while the triple point of CO₂ has a temperature of −56.6° C.

A two-phase stream 5 leaves the turbine T-100 and is sent to a phase separator V-100. The gas 6 from the separator V-100 is heated in the exchanger BAHX to form a stream 14. The stream 14 is heated in a heat exchanger E-103 and the exchanger E-101 before being sent, as stream 20, to a permeation unit M-1. A methane-enriched stream 21 leaves the unit M-1 as non-permeate and is compressed by compressors to serve as produced methane stream 23. The permeate 22 is heated in the exchanger E-103, is compressed by the compressors C-100A and sent to be mixed with the stream 16 in order to form a stream 25 sent to the compressors C-100B.

The liquid 7 is expanded in a valve and is then sent directly to the column K-100. The overhead gas 8 from the column K-100 is then recompressed in the compressors C-100B and sent back to the feed stream 1 in order to form the stream 2 at the inlet pressure. This layout makes it possible to limit the number of pieces of equipment and also to increase the CO₂ yield without introducing an external refrigeration cycle. A valve may make it possible to reduce the pressure of the stream 7 and of the column if necessary (for example to improve the purity of the CO₂ drawn off from the bottom of the column as stream 9). The stream 9 is divided into two portions 10, 11. One portion 10 is divided into two portions 12, 13.

The portion 12 is heated, or even vaporized, in the exchanger BAHX in order to form a stream 15, then divided into two factions. The fraction 19 is sent back to the bottom of the column K-100 as gaseous reboiling stream.

The portion 13 is cooled in the exchanger BAHX, is expanded in a valve V, then is heated at a pressure lower than that of the stream 12, or even is vaporized at a pressure lower than that of the stream 12, in the exchanger BAHX in order to form a stream 17. Next, the stream 17 is compressed in one stage of a compressor C-200, mixed with the stream 18, compressed in two other stages of the compressor C-200, condensed, mixed with the stream 11, then pumped in a pump P-200 in order to form a pure carbon dioxide stream 27.

The fraction 18 is sent to the compressor C-200. The portion 11 is pressurized by a pump P-100.

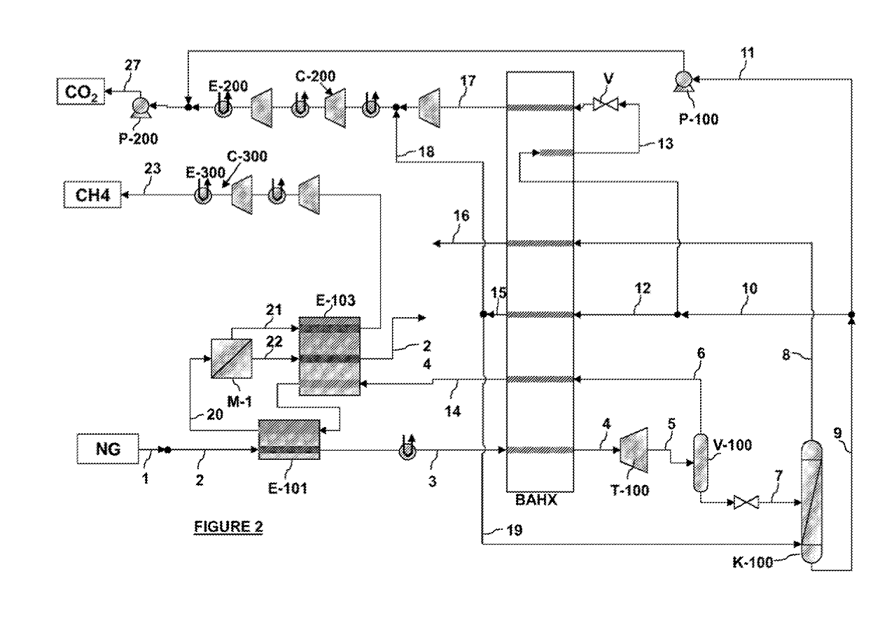

It is possible to envisage this layout without the membrane recycle (6, 14, M-1) and/or column overhead recycle (8; 16, C-100B) as illustrated in FIG. 2. Here, the permeate 22 from the membrane M-1 is cooled in the exchanger E-103 then vented to the air as stream 24. The overhead gas 8 from the column is heated in the exchanger BAHX then vented to the air as stream 16.

It is obvious that the layout as described above is only one example of an application of the invention presented and that many variations thereof are possible. It could in particular be advantageous in certain cases to include a second, or even a third partial condensation step. In this case, the turbine could for example be placed at the gas outlet of a first separator vessel.

The presence of the permeation unit M-1 or of another unit for separating the stream 20 is not essential.

The exchanger could also be physically divided into several exchangers that carry out for example different functions and that may optionally use different technologies (a BAHX-type plate exchanger and a shell and tube exchanger for example).

One conventional method for achieving a cold point temperature of −60° C. in the process would consist in using an external refrigeration cycle with a refrigerant other than CO₂ (for example a refrigerant consisting of a mixture of hydrocarbons).

In all these layouts, in order to increase the efficiency of the membranes M-1, these membranes could be used at cryogenic temperature (typically below −20° C.) instead of being used at a hot temperature.

For a feed stream 1 with a medium pressure (40-70 bar) it may be useful to begin with a compression of this stream that enables:
a condensation of the water upstream of potential dryers;
a pressure to be achieved that is sufficient to produce refrigeration using a cryogenic turbine without lowering the separation pressure.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-11. (canceled)

12. A process for separating a feed gas containing at least 20 mol % of CO₂ and at least 20 mol % of methane, by partial condensation and/or by distillation, the gas being at a pressure of at least 40 bar abs, comprising:
a) expanding at least one portion of the feed gas in a turbine producing an expanded feed stream at a pressure of less than 90 bar abs,
b) separating at least one portion of the expanded feed stream by partial condensation and/or by distillation thus obtaining a CO₂-depleted gas and a CO₂-enriched liquid,
wherein the temperature of the expanded feed gas at the outlet of the turbine is below −56.6° C., and wherein the process does not use an external refrigeration source; and wherein the CO₂-depleted gas is introduced into a supplementary separation step, in order to obtain a stream that is more depleted in CO₂ and a CO₂-rich stream.

13. The process of claim 12, wherein at least one portion of the refrigeration energy is produced by the vaporization of the CO₂-enriched liquid.

14. The process of claim 12, wherein at least one portion of the refrigeration energy is provided by expansion in one or more turbines of all or some of the CO₂-depleted gas.

15. The process of claim 12, wherein the expanded feed stream contains a liquid fraction.

16. The process of claim 15, wherein the outlet temperature of the turbine is below the triple point of CO₂.

17. The process of claim 16, wherein at least one portion of the gas phase of the expanded feed stream is compressed without first being heated upstream of the compression step.

18. The process of claim 12, wherein the expansion energy recovered in the turbine during step a) is used to pressurize one or more of the following gases:
at least one portion of the CO₂-enriched liquid after vaporization;
at least one portion of the CO₂-depleted gas;
at least one portion of the stream that is more depleted in CO₂;
at least one portion of the CO₂-rich stream.

19. The process of claim 12, wherein step b) further comprises at least one step of distillation with reboiling and wherein the overhead gas of the distillation column is recycled upstream of step b).

20. The process of claim 19, wherein the overhead gas of the distillation column is recycled upstream of step a).

21. The process of claim 20, wherein the overhead gas of the distillation column is compressed in the same compressor as the CO₂-rich stream.

22. The process of claim 18, wherein the stream that is more depleted in CO₂ is injected into a line.
